(19) United States
(12) Patent Application Publication
(10) Pub. No.: US 2009/0172208 A1
(43) Pub. Date: Jul. 2, 2009

(54) Wibro USB modem device having storage device

(76) Inventors: Ho-Joon Lee, Seoul (KR); Jung-Man Moon, Seoul (KR); Dae-Ki Kim, Seoul (KR)

Correspondence Address: COOPER & DUNHAM, LLP, 30 Rockefeller Plaza, 20th Floor, NEW YORK, NY, 10112, US

(21) Appl. No.: 12/077,548

(22) Filed: Mar. 20, 2008

(30) Foreign Application Priority Data
Jan. 2, 2008 (KR) 10-2008-0000162

(51) Int. Cl. G06F 12/02

(52) U.S. Cl. 710/13

(57) ABSTRACT

Disclosed herein is a Wireless Broadband (WiBro) Universal Serial Bus (USB) modem device having a storage device and a WiBro communication device. A USB hub is connected to the USB interface of the WiBro communication device and the USB interface of the storage device, and configured to relay data to a user terminal through a USB connector. A switching mode power supply unit is configured to have a DC-DC switching mode, receive power from the user terminal, and apply the power by performing high-speed switching so that the WiBro communication device and the storage device are simultaneously driven. The switching mode power supply unit includes a dual output switching mode power supply unit and a single output switching mode power supply unit.

### BACKGROUND OF THE INVENTION

1. Field of the Invention

The present invention relates generally to a Wireless Broadband (WiBro) Universal Serial Bus (USB) modem device, and, more particularly, to a WiBro USB modem device which includes a WiBro USB module capable of enabling the use of the wireless Internet using a notebook, a desktop Personal Computer (PC), a Ultra-Mobile PC (UMPC), and a Portable Multimedia Player (PMP), and a storage device capable of storing data, downloaded over the wireless Internet, in the area of a portable disk in real time.

2. Description of the Related Art

Recently, in order to meet rapid changes in the network environment and the demands for more convenient data storage and mobility, various types of portable storage media have been proposed. In response to the market demands, high-capacity portable storage devices using NAND flash memory have been proposed.

Such a high-capacity portable storage device basically uses a USB interface. The USB interface does not require a separate power supply adaptor but uses power (+5 V) supplied from a user terminal, such as a PC. Furthermore, the USB interface has a considerably small size, and thus it has the characteristics of portability and mobility.

The USB standard provides a general purpose interface, which can be applied to a computer or a portable device. The USB standard supports has an excellent transmission rate, excellent compatibility, and the ability to be used at any time, and therefore it has been applied to principal parts of electronic products.

Therefore, increasingly small and light USB memory, in which portability and mobility are maximized, has already been commercialized, and a large number of users easily carry and use USB memory nowadays.

However, USB supports a subordinate structure in which a user terminal acts as a host and a peripheral device acts as a client which is subordinate to and accesses the host. In this structure, the host is responsible for all types of management.

As described above, since the use of USB requires connection in a subordinate relationship, a USB device which is desired to be connected to the USB of a portable user terminal, that is, a host, is required to be directly connected to the USB port of the portable user terminal. Therefore, in order to provide a function of personal portable storage service to a personal portable Internet USB modem which has a single USB port, the service should be provided in such a way that the internal control unit of a device is designed, switching between USB interfaces for respective services is selectively performed according to a user request, and connection with the USB port of the portable user terminal, that is, the host, is provided.

Further, due to the USB power supply environment (2500 mW/5 V) of the portable user terminal, which is used as a host, the simultaneous provision of personal portable Internet service and personal portable storage service, which require high-speed/high-capacity transmission, is restricted, and thus the personal portable Internet service and the personal portable storage service must be selectively provided, with the result that the simultaneous provision of two types of services cannot be realized.

Meanwhile, in the case in which an additional function of using a USB interface in addition to a wireless Internet USB modem is internally provided, an existing wireless Internet USB modem employs a method of including a mechanical switch and a control circuit, connecting a USB interface corresponding to a desired function to the USB interface of a host, and then providing the desired function. That is, the existing wireless Internet USB modem has a structure in which a user cannot but select and use only one of the two functions, which is a structure which cannot provide a real-time dual mode service for various types of multimedia services and storage services based on information and communication technologies, which are rapidly developing nowadays.

Further, in the case in which a method of designing a power supply using an existing Low Drop Output (LDO) regulator is employed, the power supplied from the USB of a host is restricted (to 5 V @ 500 mA). Therefore, in the case in which two functions are provided using a single USB port, a phenomenon in which power is insufficient occurs, so that functions cannot be simultaneously provided.

In the case in which a power supply circuit is designed using an LDO regulator, linear output is continuously generated when power supplied from a host is applied, so that a current consumption is increased. As the current consumption increases, power efficiency is considerably deteriorated due to the increase in power, which is the product of voltage and current, and loss voltage, which drops for power conversion, with the result that 50% or less of the voltage that is applied can be used.

In summary, the conventional USB modem device cannot simultaneously provide two functions, so that a problem occurs in that it cannot access the wireless Internet while storing desired data over the Internet in real time.

### SUMMARY OF THE INVENTION

Accordingly, the present invention has been made keeping in mind the above problems occurring in the prior art, and an object of the present invention is to provide a WiBro USB modem device having a storage device which can not only support the wireless Internet via a WiBro USB function but also store data downloaded over the Internet, using a USB hub.

In order to accomplish the above-described object, the present invention provides a Wireless Broadband (WiBro) Universal Serial Bus (USB) modem device having a storage device and a WiBro communication device, the WiBro USB modem device including a USB hub connected to the USB interface of the WiBro communication device and the USB interface of the storage device, and configured to relay data to a user terminal through a USB connector; and a switching mode power supply unit configured to have a DC-DC switching mode, receive power from the user terminal, and apply the power by performing high-speed switching so that the WiBro communication device and the storage device are simultaneously driven.

Preferably, the switching mode power supply unit includes a dual output switching mode power supply unit for outputting first power to the WiBro communication device, the storage device and the USB hub, and outputting second power to the WiBro communication device, high-speed switching being performed on the respective powers; and a single output switching mode power supply unit for applying third power to the WiBro communication device, high-speed switching being performed on the third power.

Preferably, the storage device is NAND flash memory.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a WiBro USB modem device having a storage device according to an embodiment of the present invention; and

FIG. 2 is a diagram showing the switching mode power supply unit of FIG. 1 in detail.

### DESCRIPTION OF THE PREFERRED EMBODIMENTS

Hereinafter, embodiments of the present invention will be described in detail with reference to the attached drawings.

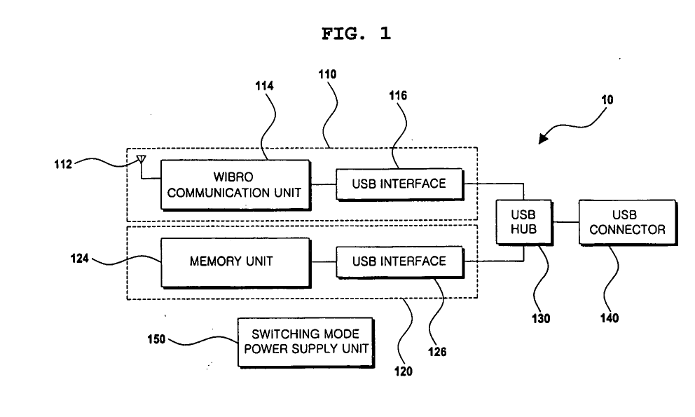

FIG. 1 is a block diagram showing the configuration of a WiBro USB modem device having a storage device according to an embodiment of the present invention.

A wireless modem device 10 using USB according to an embodiment of the present invention includes a WiBro communication device 110 configured to support wireless Internet communication, a storage device 120 configured to store data, a USB hub 130 connected to the USB interface 116 of the WiBro communication device 110 and the USB interface 126 of the storage device 120 and relay data to a user terminal (not shown) through a USB connector 140, the USB connector 140 connected to the user terminal, and a switching mode power supply unit 150 configured to have a DC-DC switching mode and supply power to each of the units.

The WiBro communication device 110 includes an antenna 112 configured to communicate with an external wireless base station, a WiBro communication unit 114 configured to access a WiBro communication network using the antenna 112, and a USB interface 116 configured to convert a signal into USB data.

The antenna 112 receives a signal, output from the wireless base station, transmits the signal to the WiBro communication unit 114, and transmits a signal, received from the WiBro communication unit 114, to the external wireless base station over a communication network.

The WiBro communication unit 114 demodulates a Radio Frequency (RF) signal received from the antenna 112, and performs signal processing in compliance with a protocol defined in a standard.

The USB interface 116 converts a baseband signal, on which demodulation is performed by the WiBro communication unit 114, into USB data, and transmits the resulting data to the USB hub 130. Further, the USB interface 116 converts the USB data, input from the USB hub 130, into a baseband signal, and transmits the resulting signal to the WiBro communication unit 114.

The storage device 120 includes a memory unit 124 for storing data downloaded through the WiBro communication unit 114, and the USB interface 126 for converting a signal into USB data.

The memory unit 124 includes, for example, NAND flash memory.

The USB interface 126 converts data, downloaded from the WiBro communication unit 114, into USB data, and transmits the resulting data to the USB hub 130. Further, the USB interface 126 converts the USB data, input from the USB hub 130, into data capable of being stored in the memory unit 124, and transmits the resulting data to the memory unit 124.

The USB hub 130 is connected to the USB interface 116 of the WiBro communication device 110 and the interface 126 of the WiBro storage device 120, and relays data to a user terminal through the USB connector 140, thereby performing a function of communication between a portable user terminal and an USB interface through the USB connector 140.

The USB hub 130 includes an Up Stream (US) port and a Down Stream (DS) port. The US port is connected to the USB interface of the host, and transmits both USB data transmitted from the USB interface 116 connected to the WiBro communication unit 114 connected to the DS port, and USB data transmitted from the USB interface 126 connected to the memory unit 124, to the host, thereby simultaneously providing two types of functions to a user.

The USB connector 140 accesses a portable user terminal, such as a notebook, a desk top PC, a UMPC, or a PMP, and transmits and receives USB data.

The switching mode power supply unit 150 receives power from the user terminal, and applies power by performing high-speed switching so that the WiBro communication device 110 and the storage device 120 are simultaneously driven.

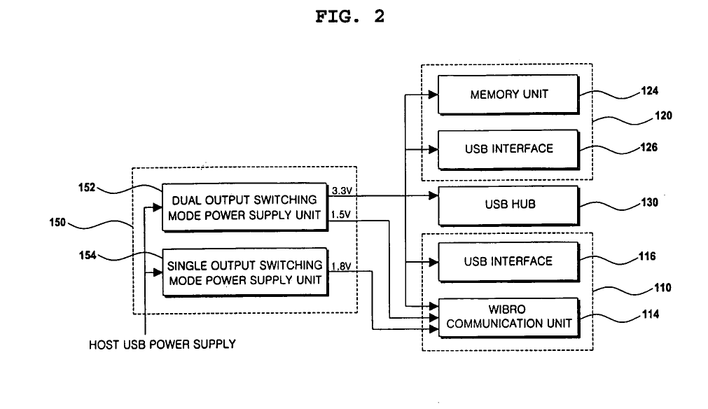

The switching mode power supply unit 150 will be described in further detail with reference to FIG. 2.

FIG. 2 is a diagram showing the switching mode power supply unit of FIG. 1 in detail.

The wireless modem device 10 using USB according to the embodiment of the present invention improves power efficiency using a DC-DC switching mode as a power supply method, thereby simultaneously providing two types of functions of performing Internet communication and storing data, using a single USB port.

As shown in FIG. 2, the switching mode power supply unit 150 includes a dual output switching mode power supply unit 152 for outputting two types of power, and a single output switching mode power supply unit 154 for outputting a single type of power.

The dual output switching mode power supply unit 152 outputs first power to the WiBro communication device 110, the storage device 120, and the USB hub 130, and outputs second power to the WiBro communication device 110. Here, high-speed switching is performed on the respective power.

The single output switching mode power supply unit 154 applies third power to the WiBro communication device 110. Here, high-speed switching is performed on the third power.

As described above, the switching mode power supply unit 150 is configured to have a switching mode so that power consumption, generated when the WiBro communication device 110 and the storage device 120 are simultaneously operated, does not exceed the limited USB power supply environment (2500 mW/5 V@500 mA) of the user terminal, thereby supporting the efficiency of the power supply.

Further, the switching mode power supply unit 150 is configured to perform DC-DC switching. When pulses are generated using high-speed switching frequencies, that is, output voltage is generated by repeatedly turning on/turning off power, and passes through a smoothing circuit, DC power, which is the same as the input power of the host USB of the portable user terminal, is generated. Further, due to the operation of turning on/turning off power, power efficiency is greatly improved, so that high-efficiency power, which is capable of using 90% or more of the voltage that is input, is provided.

The switching mode power supply unit 150 is manufactured by determining the point at which the minimum current is consumed and using the point to the circuit design so as to increase the efficiency of a power supply circuit and improve the current consumption in modules having respective functions. For this purpose, peripheral circuits that have no relationship with functional operations are omitted, and optimization for minimum current consumption is realized.

Based on the above-described configuration, functions of providing a personal portable Internet service and storing data are simultaneously provided to a single terminal using a USB hub and a switching mode power supply unit configured to have a DC-DC switching mode, thus enabling not only the wireless Internet to be used at a desired place and time but also data, downloaded over the Internet, to be stored in real time.

The WiBro USB modem device having a storage device according to the present invention is configured such that a WiBro communication device, which uses a USB interface, and a storage device, which uses a USB interface, form a subordinate relationship in the form of branches with respect to the USB host of a portable user terminal using a USB hub, and is configured such that both the WiBro communication device and the storage device can be connected to the USB port of the portable user terminal, and is configured to include a switching mode power supply in order to effectively uses the limited USB power supply environment (2500 mW/5 V) of the portable user terminal, and thus the present invention is advantageous in that the WiBro USB modem device having a storage device can be simply carried and conveniently used, the wireless Internet can be easily and rapidly used using a notebook or a desktop PC on which a USB port is mounted, and data, downloaded over the wireless Internet, can simultaneously be stored in real time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Wireless Broadband (WiBro) Universal Serial Bus (USB) modem device having a storage device and a WiBro communication device, the WiBro USB modem device comprising:
a USB hub connected to a USB interface of the WiBro communication device and a USB interface of the storage device, and configured to relay data to a user terminal through a USB connector; and
a switching mode power supply unit configured to have a DC-DC switching mode, receive power from the user terminal, and apply the power by performing high-speed switching so that the WiBro communication device and the storage device are simultaneously driven.

2. The WiBro USB modem device as set forth in claim 1, wherein the switching mode power supply unit comprises:
a dual output switching mode power supply unit for outputting first power to the WiBro communication device, the storage device and the USB hub, and outputting second power to the WiBro communication device, high-speed switching being performed on the respective powers; and
a single output switching mode power supply unit for applying third power to the WiBro communication device, high-speed switching being performed on the third power.

3. The WiBro USB modem device as set forth in claim 1, wherein the storage device is NAND flash memory.
